(19) United States
(12) Patent Application Publication
(10) Pub. No.: US 2010/0134817 A1
(43) Pub. Date: Jun. 3, 2010

(54) METHOD FOR LIMITING ADDRESS SETTING OPERATION AND PROGRAM FOR THE SAME

(75) Inventor: Yuko TORII, Atsugi-shi (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/624,545

(22) Filed: Nov. 24, 2009

(30) Foreign Application Priority Data
Dec. 2, 2008 (JP) 2008-307428

(51) Int. Cl. G06K 15/00; G06F 3/12; G06F 15/00

(52) U.S. Cl. 358/1.13; 358/1.14; 358/1.15

(57) ABSTRACT

There is described an address setting limitation method and a computer readable storage medium storing a computer executable program, each of which is to be employed in a system in which an address for indicating a data storing/referring destination is settable and makes it possible to improve a usability and convenience of the user while maintaining security aspects of the system. The method to be employed in the system in which an address for indicating a storing/referring destination of a data is settable, includes: displaying a first screen on which a first address established in advance by a manager is displayed; and displaying a second screen from which a user establishes a second address; wherein both the first address and an inputting area, from which the second address to be ranked at a hierarchy level lower than that of the first address is settable, are displayed on the second screen.

This application is based on Japanese Patent Application NO. 2008-307428 filed on Dec. 2, 2008, with Japan Patent Office, the entire content of which is hereby incorporated by reference.

### BACKGROUND OF THE INVENTION

The present invention relates to a method for limiting an address setting operation and a program for limiting an address setting operation, each of which is to be employed for a system in which addresses, representing a data storage destination and/or a data referring destination, are settable.

In recent years, various kinds of printing apparatuses, such as a printer, a Digital MFP (Multi Function Peripheral), etc., (hereinafter, referred to as an image forming apparatus as a general term for each of them) have been increasingly proliferated in the market, and have been widely utilized in various kinds of companies, etc. Generally speaking, the image forming apparatus is provided with a data storage section, which makes it possible for the user not only to store print data created by operating the computer terminal device, scan data acquired by making an image reading section of the image forming apparatus scan a certain document, etc., therein, but also to implement a kind of printing, such as a printing operation, etc., by referring to the print data stored in advance.

On those occasions, it has been cumbersome for the user to designate a destination name (hereinafter, referred to as an address) of the storage into which the concerned data is to be stored, every time when the user intends to store and/or refer the data. Conventionally, to overcome such the inconvenience, an address arbitrarily established by the user has been stored in advance to display the address on the operating screen, so that the user can conduct a printing operation by using the data stored in the storage indicated by the address concerned, or can store the scan data into the storage indicated by the address concerned.

Further, sometimes, a manager has established an address by himself, or has limited a usable scope of a specific address established by the user. For instance, Tokkai 2006-211533 (Japanese Patent Application Laid-Open Publication) sets forth a network facsimile apparatus, which makes it possible for the manager to designate a group or a scope of addresses, usages of which are to be banned or allowed. On the other hand, Tokkai 2008-92424 (Japanese Patent Application Laid-Open Publication) sets forth an image forming apparatus, which makes it possible for the manager, etc. to establish a general purpose setting value by providing an intermediate custom setting range between a default setting value and a user custom setting value.

In this connection, if the system is so constituted that the user can freely establish an address, sometimes, the user would establish such an address that is not desired by the manager due to a certain security problem. Further, when the manager changes the name of the host apparatus, each of the users should also change the address established in advance, in accordance with the changed name of the host apparatus, etc.

On the other hand, when the system is so constituted that the manager is allowed to establish an address by himself, or is allowed to limit the usable scope of the specific address established by the user, it becomes impossible for the user to store each of the various kinds of data in a easily controllable mode, since the user can access only such an address that is established by the manager or does not fall into the usable scope by the manager to utilize data of the address. Further, the user cannot utilize even such an address that has no security problem, unless the manager has established the address of the data or has released the limitation in regard to the data.

Further, when handling information to be concealed, it is necessary for the manager to limit the establishment of its address. However, when handling no information to be concealed, it is unnecessary for the manager to limit the establishment of its address. Accordingly, an operating mode of whether or not the manager limits the establishment of address to be conducted by the user should be determined depending on the utility mode of the system concerned, and therefore, it is undesirable to fix the operating mode at either the limiting mode or the non-limiting mode.

The problems as aforementioned have arisen not only in such the case that various kinds of data are stored in the image forming apparatus, but also in an arbitral system in which addresses, representing a data storage destination and/or a data referring destination, are settable, as well.

### SUMMARY OF THE INVENTION

To overcome the abovementioned drawbacks in conventional systems, it is one of objects of the present invention to provide an address setting limitation method and a computer readable storage medium storing a computer executable program, each of which is to be employed in a system in which an address for indicating a data storing/referring destination is settable and makes it possible to improve a usability and convenience of the user while maintaining security aspects of the system.

Accordingly, at least one of the objects of the present invention can be attained by any one of the address setting limitation methods and the computer readable storage medium, described as follows.

(1) According to an address setting limitation method reflecting an aspect of the present invention, the address setting limitation method to be employed in a system in which an address for indicating a storing/referring destination of a data is settable, comprises: displaying a first screen on which a first address established in advance by a manager is displayed; and displaying a second screen from which a user establishes a second address; wherein both the first address and an inputting area, from which the second address to be ranked at a hierarchy level lower than that of the first address is settable, are displayed on the second screen.
(2) According to another aspect of the present invention, in the address setting limitation method recited in item 1, a plurality of first addresses established in advance by the manager are displayed on the first screen in a selectable manner; and selected first addresses, defined as at least a part of the plurality of first addresses selected from the first screen, and the inputting area from which, with respect to each of the selected first addresses, the second address to be ranked at a hierarchy level lower than that of said each of the selected first address is settable, are displayed on the second screen.
(3) According to still another aspect of the present invention, the address setting limitation method, recited in item 1, further comprises: connecting the second address inputted from the inputting area with the first address in such a manner that the second address is positioned at the hierarchy level lower than that of the first address, when an address registering operation is instructed from the second screen, so as to create a third address in which the first address and the second address are combined with each other; and registering the third address as an address inherent to the user.
(4) According to still another aspect of the present invention, the address setting limitation method, recited in item 1, further comprises: displaying a third screen for setting a presence or absence of a manager's limitation; wherein, when the absence of the manager's limitation is established from the third screen, the first address established by the manager is not displayed on the second screen, but the second address inputted from the inputting area is registered as an address inherent to the user.
(5) According to still another aspect of the present invention, in the address setting limitation method recited in item 1, the data is a print data based on which an image forming apparatus performs an printing operation, or a scan data which is acquired by the image forming apparatus.
(6) According to a computer readable storage medium reflecting yet another aspect of the present invention, the computer readable storage medium stores a computer executable program to be employed in a system in which an address for indicating a storing/referring destination of a data is settable, the program being executable by a computer to cause the computer to perform a process comprising: displaying a first screen on which a first address established in advance by a manager is displayed on a displaying section; and displaying a second screen from which a user establishes a second address on the displaying section; wherein both the first address and an inputting area, from which the second address to be ranked at a hierarchy level lower than that of the first address is settable, are displayed on the second screen.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram indicating an address setting limitation method embodied in the present invention;

FIG. 2 shows a schematic diagram indicating a configuration of a printing system embodied in the present invention;

FIG. 3 shows a block diagram indicating a detailed configuration of a printing system embodied in the present invention;

FIG. 4 shows a schematic diagram indicating another configuration of a printing system embodied in the present invention;

FIG. 5 shows a schematic diagram indicating still another configuration of a printing system embodied in the present invention;

FIG. 6 shows an exemplary layout of a screen (menu screen) to be displayed on a security management apparatus embodied in the present invention;

FIG. 7 shows an exemplary layout of a screen (print start screen) to be displayed on a security management apparatus embodied in the present invention;

FIG. 8 shows an exemplary layout of a screen (scan start screen) to be displayed on a security management apparatus embodied in the present invention;

FIG. 9 shows an exemplary layout of a screen (manager's limitation change screen) to be displayed on a client terminal device embodied in the present invention;

FIG. 10 shows an exemplary layout of a screen (scanning address setting list screen for a manager) to be displayed on a client terminal device embodied in the present invention;

FIG. 11 shows an exemplary layout of a screen (scan address setting list screen for a general user) to be displayed on a client terminal device embodied in the present invention;

FIG. 12 shows an exemplary layout of a screen (scan address setting selection screen, when a manager's limitation is present) to be displayed on a client terminal device embodied in the present invention;

FIG. 13 shows an exemplary layout of a screen (scan address setting registration screen, when a manager's limitation is present) to be displayed on a client terminal device embodied in the present invention;

FIG. 14 shows an exemplary layout of a screen (scan address setting selection screen, when a manager's limitation is absent) to be displayed on a client terminal device embodied in the present invention;

FIG. 15 shows an exemplary layout of a screen (scan address setting selection screen, when a manager's limitation is absent) to be displayed on a client terminal device embodied in the present invention;

FIG. 16 shows a flowchart indicating an operational procedure for creating an address list data in a printing system embodied in the present invention;

FIG. 17 shows an exemplary structure of data (manager's limitation setting data) to be utilized in the printing system embodied in the present invention;

FIG. 18 shows an exemplary structure of data (manager setting data) to be utilized in the printing system embodied in the present invention;

FIG. 19 shows an exemplary structure of data (user setting data) to be utilized in the printing system embodied in the present invention; and

FIG. 20 shows an exemplary structure of data (address list data) to be utilized in the printing system embodied in the present invention.

### DETAILED DESCRIPTION OF THE PREFERRED EMBODIMENT

As described in the “BACKGROUND OF THE INVENTION”, with respect to the operation for setting an address when storing various kinds of data, such as print data, scan data, etc., conventional systems are so constituted that the user can freely establish the addresses of them, or the manager is allowed either to establish the addresses of them by himself or to limit the usable scope of the specific address established by the user. Accordingly, there have been problems that it is impossible to secure the security of the system by employing the former method, while the user's convenience is defected by employing the latter method. Further, when the system operating mode is fixed at either the former or the latter, there has arisen the other problem that the system operating mode could not be in conformity with the system utility mode.

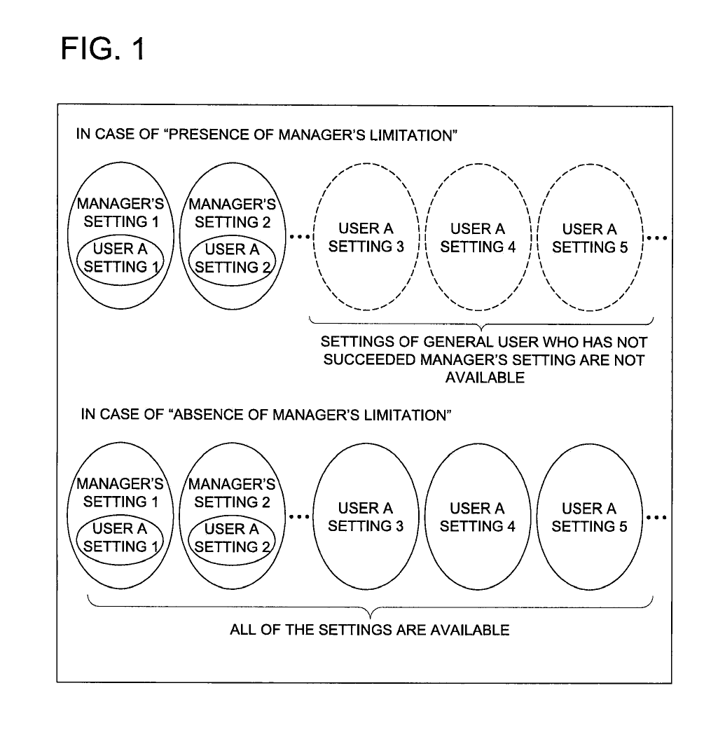

To overcome the abovementioned problems, according to the system embodied in the present invention, as shown in FIG. 1, in the system in which an address representing a destination for referring print data, another address representing a destination for storing scan data acquired by implementing a scanning operation, etc., are settable, when the manager wishes to apply an usage limitation to the address to be established by the user, the manager makes each of the users succeed the address established by the manager, so that each of the users can use only a folder having such an address that is to be ranked at a hierarchy level lower than that of the succeeded address (lower hierarchy), as indicated in the upper stage of the schematic diagram shown in FIG. 1.

### Embodiment

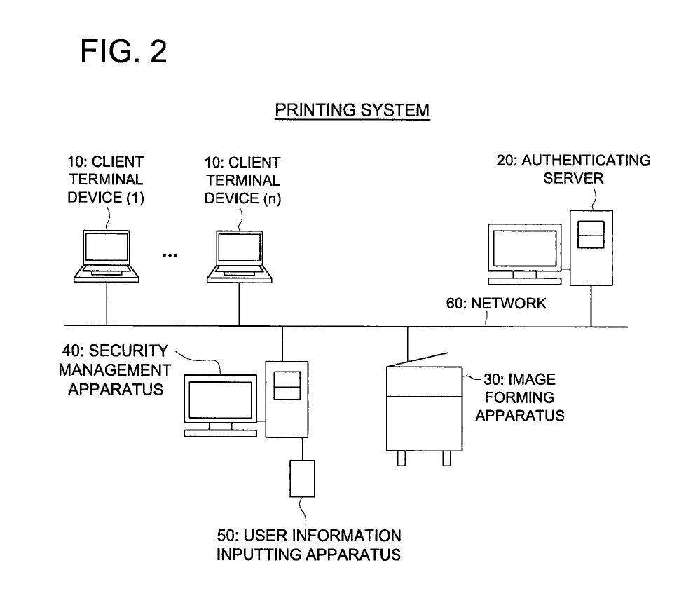

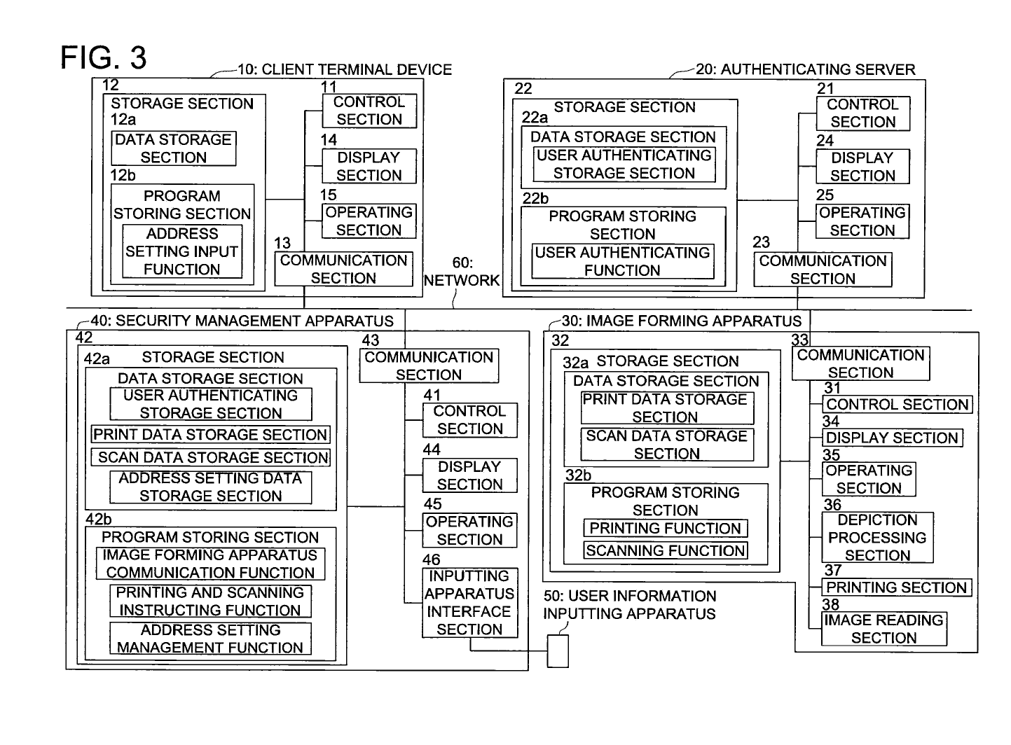

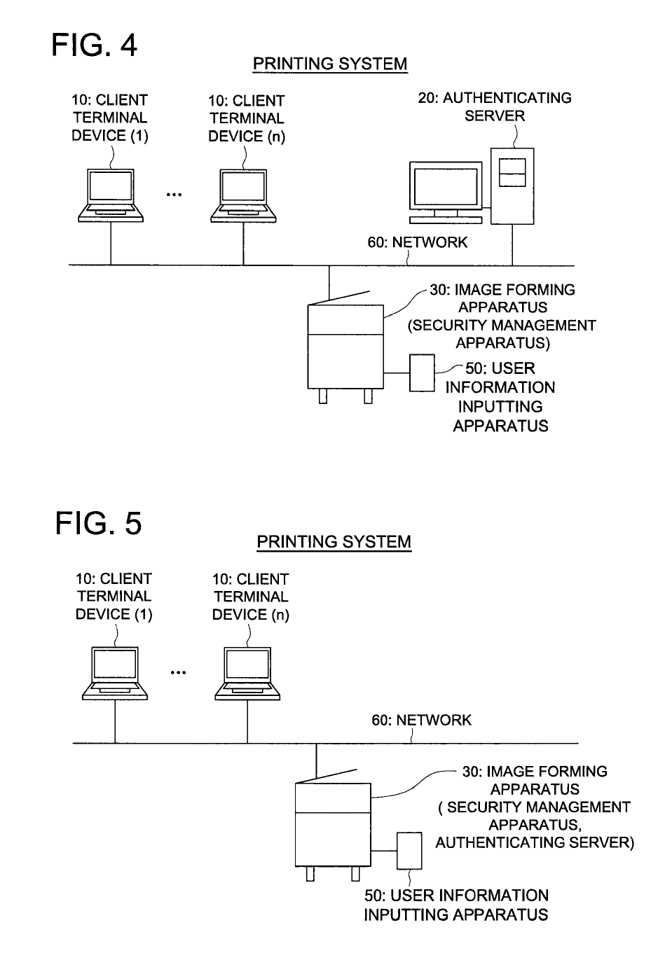

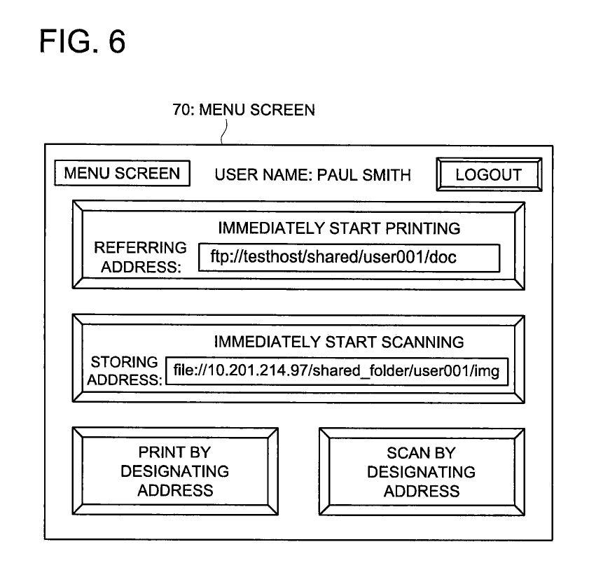

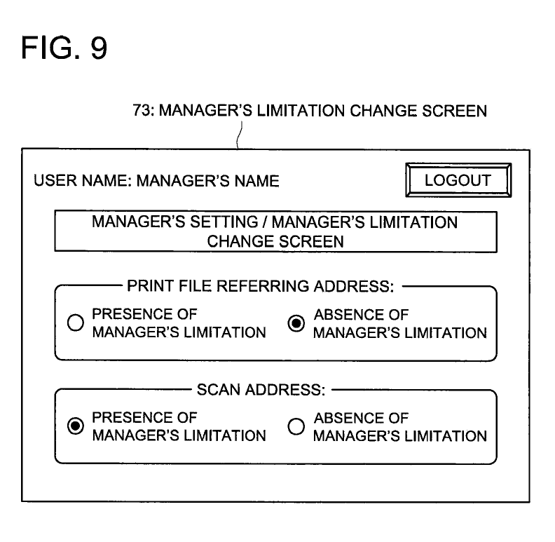

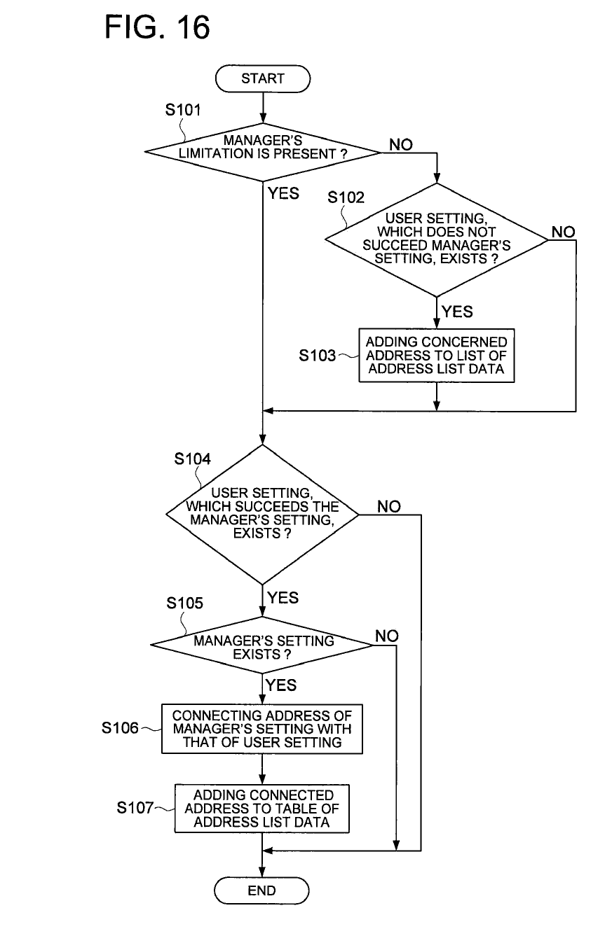

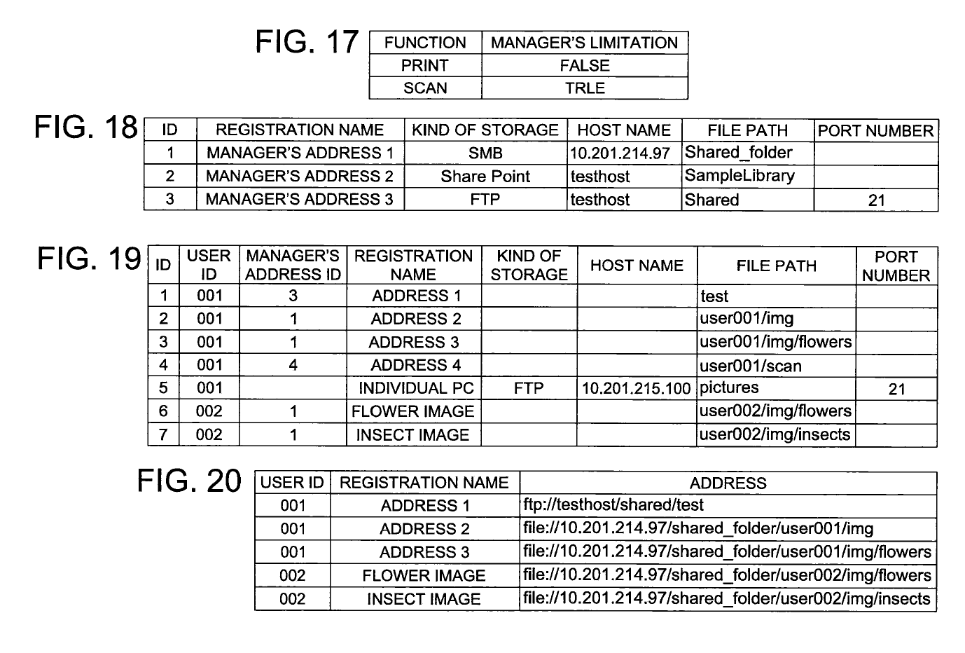

In order to describe the preferred embodiment of the present invention in detail, referring to FIG. 2 through FIG. 20, a method for limiting an address setting operation and a program for limiting an address setting operation, embodied in the present invention, will be detailed in the following. FIG. 2 shows a schematic diagrams indicating a configuration of a printing system embodied in the present invention, FIG. 3 shows a block diagram indicating concrete configurations of the apparatuses included in the printing system, while FIG. 4 and FIG. 5 show schematic diagrams indicating other configurations of the printing system embodied in the present invention. Further, FIG. 6 through FIG. 8 show exemplary layouts of screens to be displayed on a security management apparatus embodied in the present invention, while FIG. 9 through FIG. 15 show exemplary layouts of screens to be displayed on a client terminal device embodied in the present invention. Still further, FIG. 16 shows a flowchart indicating an operational procedure for creating an address list data, while FIG. 17 through FIG. 20 show exemplary structures of data to be utilized in the printing system embodied in the present invention.

As shown in FIG. 2, the printing system, embodied in the present invention, includes a client terminal device 10 serving as a computer terminal device equipped at a user's site, an authenticating server 20, such as an AD (Active Directory), an LDAP (Lightweight Directory Access Protocol), etc., an image forming apparatus 30, such as a printer, a Digital MFP (Multi Function Peripheral), etc., and a security management apparatus 40 that controls a print job. In the printing system, the abovementioned apparatuses are coupled to each other through a network 60, such as a LAN (Local Area Network), WAN (Wide Area Network), etc. Further, a user information inputting apparatus 50 that reads user information stored in an IC card or the like, is coupled to the security management apparatus 40. Referring to FIG. 3, a concrete configuration of each of the above-mentioned apparatuses will be detailed in the following.

### <Client Terminal Device>

The client terminal device 10 is constituted by a control section 11, a storage section 12, a communication section 13, a display section 14, an operating section 15, etc.

The control section 11 is constituted by a CPU (Central Processing Unit), etc. The storage section 12 is constituted by various kinds of memories, such as a ROM (Read Only Memory), a RAM (Random Access Memory), etc., an HDD (Hard Disc Drive), etc., and is provided with a data storage section 12a into which data for the print jobs are to be stored and a program storing section 12b into which various kinds of programs for implementing an address setting input function and other functions are to be stored. With this construction, the CPU develops the programs, stored in the ROM and/or the HDD, onto the RAM so as to execute the programs developed on the RAM. In the present embodiment, the control section 11 also serves as a printer driver that creates a print job, which includes print data, such as document data written in the Page Description Language (such as the PS (Post Script), the PCL (Printer Control Language), etc.), PDF (Portable Document Format) data, etc., and then, transmits the print job to either the security management apparatus 40 or the image forming apparatus 30 so as to instruct the printing operation. Further, the control section 11 also serves as an address establishment limiting section that makes the display section 14 display a screen for the manager to conduct a manager's limitation changing operation. In addition to the above, when a general user establishes an address, the address establishment limiting section refers the address setting information acquired from the data storage section 12a or the security management apparatus 40, so as to make the display section 14 display not only an screen indicating the addresses established by the manager, but also another screen which makes it possible for the user to input an address to be ranked at a hierarchy level lower than that of concerned one of the above-mentioned addresses established by the manager. In this connection, it is applicable that the address establishment limiting section abovementioned can be structured as either hardware or a program being executable by a computer to cause the computer to perform the address establishment limiting operation, so as to make the concerned program being executed in the control section 11.

The communication section 13 is constituted by a NIC (Network Interface Card), a modem, etc., so as to make it possible to communicate with the image forming apparatus 30 and the security management apparatus 40. Further, the display section 14 is constituted by a LCD (Liquid Crystal Display), etc., so as to display a manager's limitation change screen, an address setting list screen, an address setting selection screen, an address setting registration screen, etc., which are detailed later on. Still further, the operating section 15 is constituted by a keyboard, a mouse, etc., so as to make various kinds of operations, such as an operation for creating the print job, another operation for changing the manager's limitation, still another operation for setting the address, etc., possible.

### <Authenticating Server>

The authenticating server 20 is constituted by a control section 21, a storage section 22, a communication section 23, a display section 24, an operating section 25, etc.

The control section 21 is constituted by a CPU, etc. The storage section 22 is constituted by various kinds of memories, such as a ROM, a RAM, etc., an HDD, etc., and is provided with a data storage section 22a to store user authenticating data, etc., therein, and a program storing section 22b in which various kinds of programs for implementing a user authenticating function and other functions are stored. With this construction, the CPU develops the programs, stored in the ROM and/or the HDD, onto the RAM so as to execute the programs developed on the RAM. In the present embodiment, the control section 21 also serves as a user authenticating section that executes the user authenticating program, so as to conduct the user authenticating operation by comparing the user information transmitted from the security management apparatus 40 with the user authenticating data stored in the data storage section 22a.

The communication section 23 is constituted by a NIC, a modem, etc., so as to make it possible to communicate with the image forming apparatus 30 and the security management apparatus 40. Further, the display section 24 is constituted by a LCD, etc., so as to display a user authenticating screen, etc. Still further, the operating section 25 is constituted by a keyboard, a mouse, etc., so as to make various kinds of operations with respect to the user authentication possible.

### <Image Forming Apparatus>

The image forming apparatus 30 is constituted by a control section 31, a storage section 32, a communication section 33, a display section 34, an operating section 35, a depiction processing section 36, a printing section 37, an image reading section 38, etc.

The control section 31 is constituted by a CPU (Central Processing Unit), etc. The storage section 32 is constituted by various kinds of memories, such as a ROM (Read Only Memory), a RAM (Random Access Memory), etc., an HDD (Hard Disc Drive), etc., and is provided with a data storage section 32a into which print data, scan data, etc. are to be stored and a program storing section 32b into which various kinds of programs for implementing a printing function, a scanning function and other functions are to be stored. With this construction, the CPU develops the programs, stored in the ROM and/or the HDD, onto the RAM so as to execute the programs developed on the RAM. In this connection, the scope of the destination storage into which the print data and the scan data are to be stored is not limited to the data storage section 32a abovementioned. It is also applicable that the print data and the scan data are to be stored in an external storage equipped outside the image forming apparatus 30, a server coupled to the network 60, etc.

The communication section 33 is constituted by a NIC, a modem, etc., so as to make it possible to communicate with the authenticating server 20 and the security management apparatus 40. Further, the display section 34 is constituted by a LCD, etc., so as to display an operating screen, etc. Still further, the operating section 35 is constituted by a touch panel, etc., so as to make various kinds of operations to be conducted at the image forming apparatus 30 possible.

The depiction processing section 36 parses the print data received from the client terminal device 10 and/or the security management apparatus 40, and rasterizes the print data so as to create bitmap data being available for the printing operation, and at the same time, applies various kinds of image processing, such as a color conversion processing, a density adjustment processing, etc., to the above-created bitmap data as needed.

The printing section 37 is constituted by various kinds of image forming elements, which are necessary for implementing the image forming process employing an electro-photographic method, an electrostatic recording method, etc., namely, a charging device, a photoreceptor drum, an exposure device, a developing device, a transferring roller, a transferring belt, a fixing device, etc. Concretely speaking, the exposure device irradiates a light beam modulated corresponding to the bitmap data onto the circumferential surface of the photoreceptor drum uniformly charged by the charging device so as to form an electrostatic latent image, thereon. Then, the developing device develops the latent image with toner so as to form a toner image on the photoreceptor drum. Successively, the toner image formed on the photoreceptor drum is transferred onto a paper sheet medium through the primary transfer roller and the secondary transfer roller, and finally, the fixing device fixes the toner image onto the paper sheet medium by applying heat and pressure thereon.

The image reading section 38 is constituted by a light source to emit a light beam scanning a document placed on the document placing plate, a CCD (Charge Coupled Device) image sensor to convert the light reflected from the document to analogue electric signals, an A/D (Analogue to Digital) converter to convert the analogue electric signals, outputted by the CCD image sensor, to digital image data, etc., in order to generate the digital image data by optically reading the document image.

### <Security Management Apparatus>

The security management apparatus 40 is constituted by a control section 41, a storage section 42, a communication section 43, a display section 44, an operating section 45, an inputting apparatus interface section 46, etc.

The control section 41 is constituted by a CPU, etc. The storage section 42 is constituted by various kinds of memories, such as a ROM (Read Only Memory), a RAM (Random Access Memory), etc., an HDD (Hard Disc Drive), etc., and is provided with a data storage section 42a into which the user authenticating data, the print data, the scan data, the address setting information (the manager's limitation setting data, the manager setting data, the user setting data, the address list data), etc. are to be stored and a program storing section 42b into which various kinds of programs for implementing a function for communicating with the image forming apparatus 30, a printing and scanning instructing function for instructing the image forming apparatus 30 to conduct the printing operation and to implement the scanning operation, an address setting management function for creating the address list data, etc., are stored. With this construction, the CPU develops the programs, stored in the ROM and/or the HDD, onto the RAM so as to execute the programs developed on the RAM.

The communication section 43 is constituted by a NIC, a modem, etc., so as to make it possible to communicate with the authenticating server 20 and the image forming apparatus 30. Further, the display section 44 is constituted by a LCD, etc., so as to display a menu screen, a print start screen, a scan start screen, etc., detailed later, thereon. Still further, the operating section 45 is constituted by a keyboard, a mouse, etc., so as to make various kinds of operations in regard to the authenticating operation, the printing operation and the scanning operation, possible. The inputting apparatus interface section 46 serves as an interface with the user information inputting apparatus 50.

### <User Information Inputting Apparatus>

The user information inputting apparatus 50 is provided with a reading section to read the user information from the IC card or the like and a communicating section to transmit the above-read user information to the security management apparatus 40. In this connection, the scope of the storage medium into which the user information is to be stored is not limited to the IC card, but a magnetic card or an RFID (Radio Frequency Identification) tag may be employed for this purpose, and further, it is also applicable that the system is so constituted that the reading section can read biological information, such as a finger print, a vein pattern, etc. Further, it is also applicable that the system is so constituted that the user information inputting apparatus 50 is provided with an inputting section instead of the reading section abovementioned, so as to make it possible to input a user ID, a password, etc., therefrom.

Incidentally, the printing system shown in FIG. 3 is merely an exemplary one of various printing systems embodied in the present invention. Its configuration can be changed as needed without departing from the spirit and scope of the invention, as far as the controlling operations conducted in the present embodiment are implementable.

For instance, by storing the programs for implementing the address establishment managing function into the program storing section 32b of the image forming apparatus 30, and by storing the address setting information into the data storage section 32a of the image forming apparatus 30, it becomes possible to make the image forming apparatus 30 also serve as the security management apparatus 40 as shown in FIG. 4, so as to make the display section 34 of the image forming apparatus 30 display each of various kinds of screens detailed later.

Further, by storing the programs for implementing the user authenticating function into the program storing section 32b of the image forming apparatus 30, and by storing the user authenticating data into the data storage section 32a of the image forming apparatus 30, it becomes possible to make the image forming apparatus 30 also serve as the authenticating server 20 as shown in FIG. 5.

Still further, by storing the programs for implementing the address setting inputting function into the program storing section 32b of the image forming apparatus 30, it is possible to configure the whole printing system only by the image forming apparatus 30 itself.

Next, various kinds of screens to be displayed in the printing system embodied in the present invention will be detailed in the following.

FIG. 6 shows an example of a menu screen 70 to be displayed on the display section 44 when the control section 41 of the security management apparatus 40 implements the printing and scanning instructing function in the event of controlling the image forming apparatus 30. Within this screen, buttons for respectively instructing the starts of printing and scanning operations are displayed, and further, addresses established by the user currently logging on are respectively displayed on the buttons. Then, if the button labeled “IMMEDIATELY START PRINTING” is clicked, it is possible to print an image represented by the print data stored at the address concerned. Further, as well as the above, if the button labeled “IMMEDIATELY START SCANNING” is clicked, it is possible to start the scanning operation, and to store the acquired scan data into the storage area designated by the address concerned.

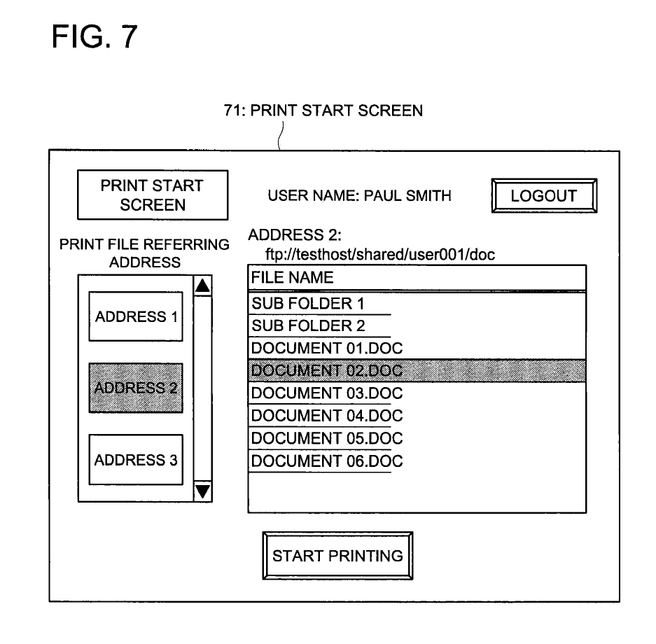

FIG. 7 shows an example of a print start screen 71 to be displayed on the display section 44 by the control section 41 of the security management apparatus 40 when the user depresses the button labeled “PRINT BY DESIGNATING ADDRESS” in the menu screen 70 shown in FIG. 6. Within this screen, a plurality of addresses established by the user currently logging on are displayed. When the user selects a desired address from the plurality of addresses abovementioned, the list of documents, which are stored in the storage area at the selected address, is displayed within the print start screen 71. Successively, when the user designates a desired document, and then, depresses the button labeled “START PRINTING”, the printing operation can be started. Further, when the printing operation based on, for instance, a file stored in the “SUB-FOLDER 1”, displayed in the print start screen 71, has completed, the control section 41 stores the selected address into the address setting storage area of the data storage section 42a, so as to display an address of “ftp://testhost/shared/user001/doc/sub-holder1”, instead of the address of “ftp://testhost/shared/user001/doc”, on the area of “ADDRESS 2” when it is displayed on a next occasion. Alternatively, the control section 41 changes the referring destination of the button labeled “IMMEDIATELY START PRINTING”, shown in FIG. 6, to the address of “ftp://testhost/shared/user001/doc/sub-holder1”. As abovementioned, it is possible to change the user setting corresponding to the utility mode.

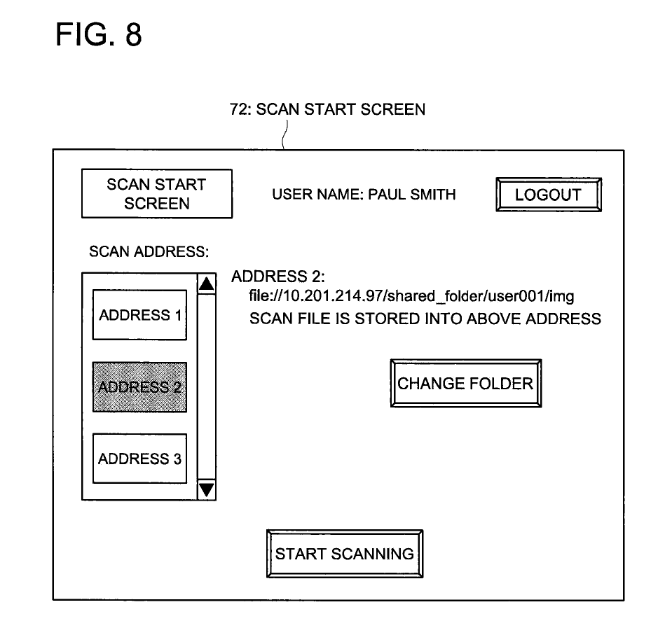

FIG. 8 shows an example of a scan start screen 72 to be displayed on the display section 44 by the control section 41 of the security management apparatus 40 when the user depresses the button labeled “SCAN BY DESIGNATING ADDRESS” in the menu screen 70 shown in FIG. 6. Within this screen, a plurality of addresses established by the user currently logging on are displayed. When the user selects a desired address from the plurality of addresses abovementioned, the scan data created by conducting the scanning operation can be stored in the storage area at the selected address. As well as the printing case shown in FIG. 7, according to this screen, it is possible to change the user setting corresponding to the utility mode, such as designating a sub-holder in the address so as to make the changed address set as an address to be used on a next occasion.

FIG. 9 shows an example of a manager's limitation change screen 73 to be displayed on the display section 14 by the control section 11 of the client terminal device 10 executing an address establishment limiting program, serving as an address establishment inputting function, when the manager logs in. Within this screen, areas, each of which is provided with two checking circles for selecting whether or not the manager's limitation should be applied to the address setting operation for the print data or the scan data, are displayed, so that the manager can select a presence or absence of the manager's limitation corresponding to the utility mode of the system concerned. The information established on this screen is to be stored in the data storage section 42a of the security management apparatus 40 as the manager's limitation setting data shown in FIG. 17.

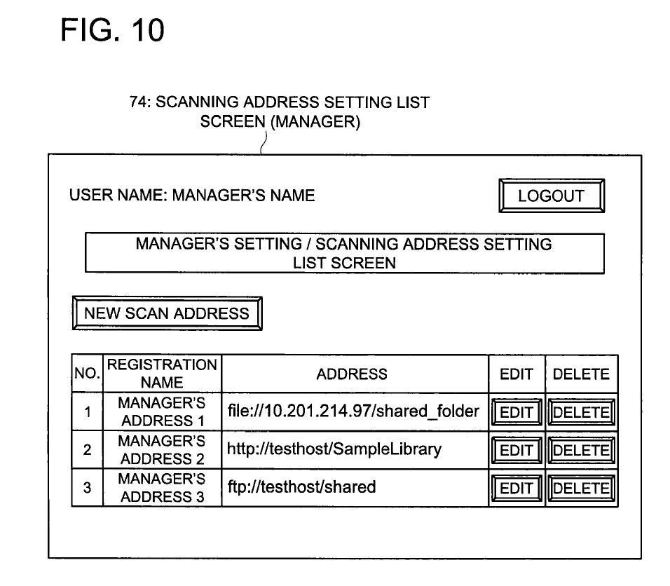

FIG. 10 shows an example of a scanning address setting list screen 74 to be displayed on the display section 14 by the control section 11 of the client terminal device 10 executing the address establishment limiting program, when the manager logs in. Concretely speaking, the control section 11 utilizes the WEB service provided by the address establishment managing function of the security management apparatus 40 to make the display section 14 display the address setting information currently stored in the address setting storage section of the data storage section 42a thereon, so as to actually implement the address establishment setting function. Within this screen, a scan data address list registered in advance by the manager is displayed, so as to make it possible to select a specific address from the scan data address list and to edit the specific address by depressing the “EDIT” button. Further, by depressing the “NEWLY SCANNING ADDRESS” button, it is possible to newly establish an address for user's use. The information established on this screen is to be stored in the data storage section 42a of the security management apparatus 40 as the manager setting data (refer to FIG. 18) from the client terminal device 10 by using the WEB service provided by the address establishment managing function of the security management apparatus 40.

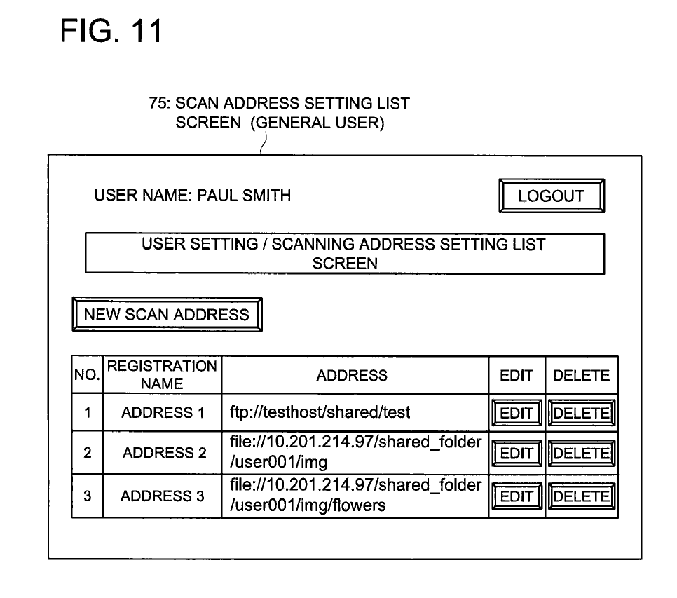

FIG. 11 shows an example of a scan address setting list screen 75 to be displayed on the display section 14 by the control section 11 of the client terminal device 10 (address setting limitation program) referring to the address list data acquired from the security management apparatus 40 when a general user logs in. Within this screen, an address list of the scan data sets, each of which is established by each of the users and each address of which is ranked at a hierarchy level lower than that of the address established in advance by the manager, so that the user can edit the address by selecting the concerned address from the scan address setting list screen 75 and depressing the “EDIT” button, under a certain limitation detailed later. Further, by depressing the “NEW SCAN ADDRESS” button, it is also possible for the user to newly establish a desired address to be used by the user concerned, under a certain limitation detailed later.

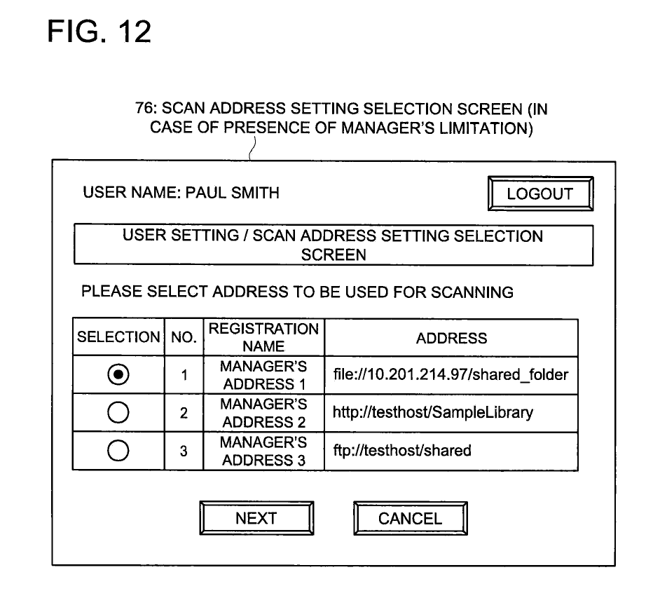

FIG. 12 shows an example of a scan address setting selection screen 76 to be displayed on the display section 14 by the control section 11 of the client terminal device 10 (address setting limitation program), when the manager checks the circle of “PRESENCE OF MANAGER LIMITATION” in the manager limitation change screen 73 shown in FIG. 9 and the general user depresses the “NEW SCAN ADDRESS” button in the scan address setting list screen 75 shown in FIG. 11. Within this screen, an address list of the scan data sets, each address of which is established in advance by the manager is displayed, so that the user can edit the address by selecting the concerned address from the scan address setting selection screen 76 and depressing the “NEXT” button, under a certain limitation detailed later.

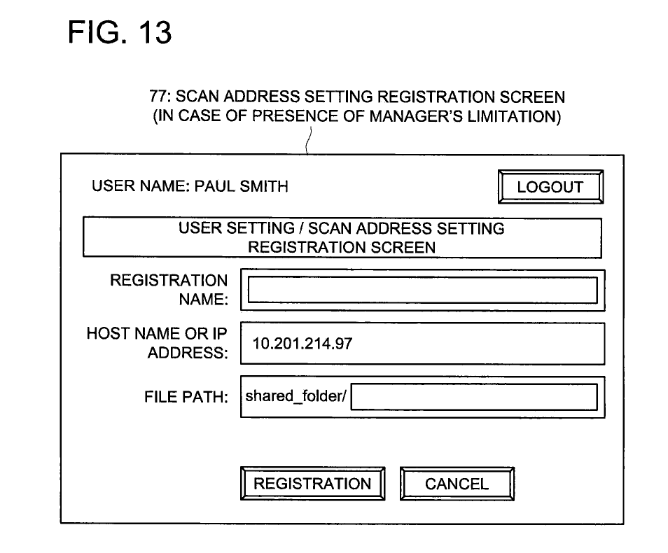

FIG. 13 shows an example of a scan address setting registration screen 77 to be displayed on the display section 14 by the control section 11 of the client terminal device 10 (address setting limitation program), when the user depresses the “NEXT” button after selecting the scan address setting selection screen 76 shown in FIG. 12, or when the user depresses the “EDIT” button of the predetermined address in the scan address setting list screen 75 shown in FIG. 11. Within this screen, plural areas, from which a registered name of the scan data address, a name of the host apparatus (IP address), a file path, etc. are to be inputted, are displayed. On that occasion, in order make it possible to limit the scope of the address setting operation to be conducted by the user only to such addresses that are to be ranked at a hierarchy level lower than those of the addresses registered by the manager, all of or a part of the addresses registered by the manager are displayed on the area from which the file path is to be inputted (in the present embodiment, “shared folder/” ranked at the lowest hierarchy), and it is possible to input an address ranked at a hierarchy level lower than that. Further, by depressing the “REGISTRATION” button after completing the inputting operation, the inputted contents (for instance, “user001”) are registered, and, at the next time when the scan address setting list screen 75 shown in FIG. 11 is displayed on the display section 14, the address reflected by the registered contents (for instance, “_shared_folder/user001”) will be displayed. The information established on this screen is stored in the data storage section 42a of the security management apparatus 40 as the user setting data (refer to FIG. 19).

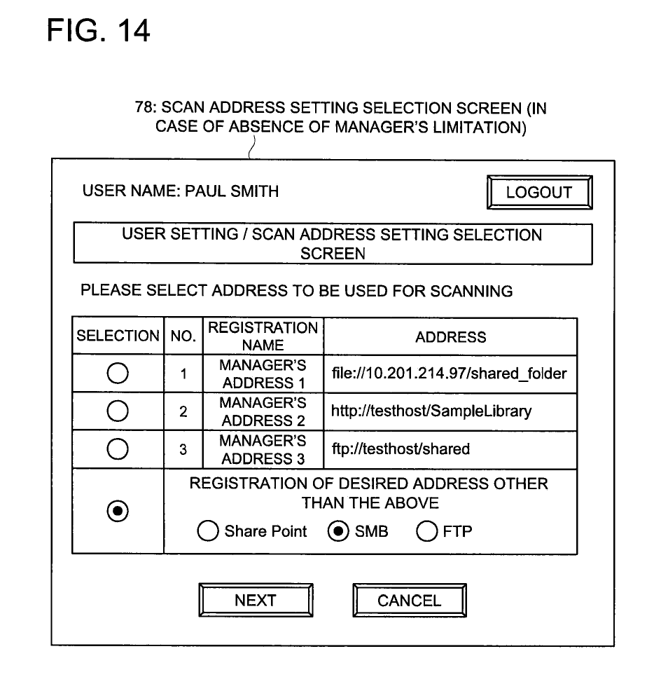

FIG. 14 shows an example of a scan address setting selection screen 78 to be displayed on the display section 14 by the control section 11 of the client terminal device 10 (address setting limitation program), when the manager checks the circle of “ABSENCE OF MANAGER LIMITATION” in the manager limitation change screen 73 shown in FIG. 9 and the general user depresses the “NEW SCAN ADDRESS” button in the scan address setting list screen 75 shown in FIG. 11. Within this screen, an address list of the scan data sets, each address of which is established in advance by the manager, is displayed, and at the same time, another area, form which an address other than the above can be registered, is also displayed, so that the general user can select an address registration being free from the addresses registered by the manager.

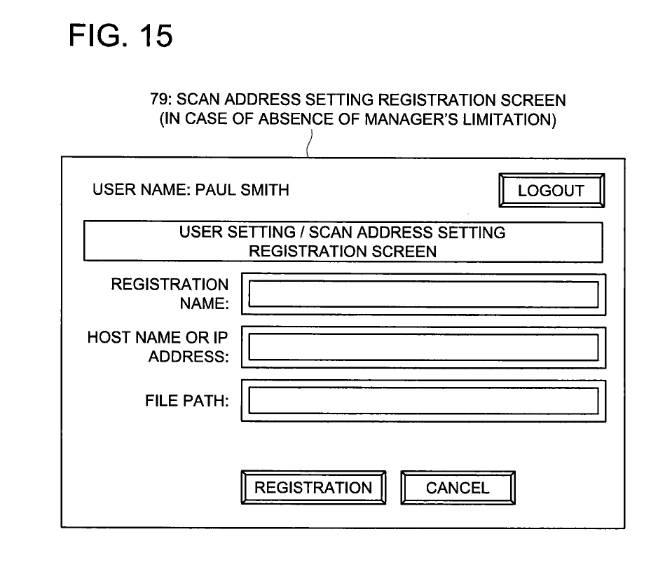

FIG. 15 shows an example of a scan address setting selection screen 79 to be displayed on the display section 14 by the control section 11 of the client terminal device 10 (address setting limitation program), when the general user depresses the “next” button after checking the selection circle of “REGISTERING DESIRED ADDRESS OTHER THAN THE ABOVE” in the scan address setting selection screen 78 shown in FIG. 14. Within this screen, although the plural areas, from which a registered name of the scan data address, a name of the host apparatus (IP address), a file path, etc. are to be inputted, are displayed, the address registered by the manager is not displayed in the area from which the file path is to be inputted, so that the user can freely input a desired address. The information established on this screen is stored in the data storage section 42a of the security management apparatus 40 as the user setting data (refer to FIG. 19).

In this connection, although the system of the present embodiment is so constituted that the screens shown in FIG. 6 through FIG. 8 are to be displayed by the security management apparatus 40 while the other screens shown in FIG. 9 through FIG. 15 are to be displayed by the client terminal device 10, an apparatus that displays any one of the screens shown in FIG. 6 through FIG. 15 is changeable as needed. For instance, it is also applicable that the system is so constituted that the screens shown in FIG. 9 through FIG. 15 are to be displayed by the security management apparatus 40 or the screens shown in FIG. 6 through FIG. 15 are to be displayed by the image forming apparatus 30. In that case, the apparatus that displays the concerned screens may be made to store a program for implementing the address establishment inputting function, so as to make the control section execute the address establishment limiting program. Further, although the exemplified layouts of the scan address setting screens are shown in FIG. 10 through FIG. 15, the screen layouts being similar to the above are also applied to the case for implementing the printing operation, etc.

Next, referring to the flowchart shown in FIG. 16, the operating procedure for creating the address list data, which is to be referred at the time when the address setting list screen is displayed, will be detailed in the following.

Initially, in Step S101, the control section 41 determines whether the manager's limitation, which is to be established by the manager from the manager's limitation change screen 73 shown in FIG. 9, is present or absent. For instance, referring to the manager's limitation setting data and according to the information (TRUE or FALSE) corresponding to each of the functions, the control section 41 determines whether the manager's limitation is present or absent.

When determining that the manager's limitation is absent (Step S101; No), the control section 41 further determines in Step S102 whether or not the user setting, which is registered from the scan address setting selection screen 79 shown in FIG. 15 and does not succeed the manager's setting, exists. When determining that the user setting, which does not succeed the manager's setting, exists (Step S102; Yes), the control section 41 adds its address to the address list data (Step S103). On the other hand, when determining that the manager's limitation is present (Step S101; Yes), even if the user setting, which does not succeed the manager's setting, exists, the control section 41 does not add its address to the address list data. In this connection, as indicated in the exemplary table of user setting data shown in FIG. 19, the user setting, which does not succeed the manager's setting, corresponds to the data of line “5”, in which the manager's address ID is blanked.

Successively, in Step S104, the control section determines whether or not the user setting, which is registered from the scan address setting registration screen 77 shown in FIG. 13 and succeeds the manager's setting, exists. When determining that the user setting, which succeeds the manager's setting (Step S104; Yes), exists, the control section 41 confirms whether or not the succeeding manager's setting exists, by referring to the table of the manager's setting data (Step S105). When determining that the succeeding manager's setting exists (Step S105; Yes), the control section 41 connects the address of the manager's setting with that of the user setting (Step S106). In this connection, as indicated in the exemplary table of user setting data shown in FIG. 19, the user setting, which succeeds the manager's setting, corresponds to each of the data of the lines other than line “5”, in each of which the manager's address ID is not blanked.

For instance as an example of the above-mentioned address connection, in case that the user selects the [file://10.201.214.97/shared_folder] of the “MANAGER'S ADDRESS 1” (corresponding to ID “1” in the example of the manager's setting data shown in FIG. 18) from the scan address setting selection screen 76, and after depressing the “NEXT” button, the user inputs “address 2” into the registration name and [user001/img] into the file path (corresponding to ID “2” in the example of the user setting data shown in FIG. 19) from the scan address setting registration screen 77 shown in FIG. 13, and then, the user depresses the “REGISTRATION” button, an address connected with the registration name “ADDRESS 2” of the user setting becomes [file://10.201.214.97/sharedfolder/user001/img] (corresponding to the data of the registration name “ADDRESS 2” in the example of the address list data shown in FIG. 20).

In other words, the address is created by connecting elements in the format indicated as follow.

[scheme corresponding to kind of storage (in case of SMB; file)]://[host name]:[port number (omit-able)]/[file path]/[file path of user (when succeeding manager's setting)]

Still successively, in Step S107, the control section 41 adds the connected address to the table of the address list data. On the other hand, when determining that the manager setting does not exist (Step S105; No) (corresponding to the data of ID “4” in the example of the user setting data shown in FIG. 19), the control section 41 does not add the connected address to the table of the address list data.

FIG. 20 shows an example of the table of the address list data created through the abovementioned procedure. Among the examples of the user setting data shown in FIG. 19, since the data of ID “4” is such data that no manager's setting data exists, the concerned data is not added into the table of the address list data. As well as the above, since the data of ID “5” is such data that does not succeed the manager's setting, when the manager's limitation is “PRESENT” as shown in FIG. 17, the concerned data is not added into the table of the address list data.

In this connection, although the above-mentioned flowchart indicates such a case that the table of the address list data is created in the security management apparatus 40, an apparatus that creates the table of the address list data is changeable as needed. Accordingly, it is also applicable that the table of the address list data is to be created in, for instance, either the client terminal device 10 or the image forming apparatus 30. In that case, the programs for implementing the function for controlling the address setting information and the address setting managing operation may be stored in the apparatus concerned. Further, although shown in FIG. 18 through FIG. 20 is the exemplified data of the scan address, a similar data can be applied to the printing case, etc., as well.

As described in the foregoing, according to the present invention, when the manager establishes the presence of the manager's limitation from the manager's limitation change screen, all of or a part of the addresses established by the manager are displayed on the address setting registration screen, and at the same time, the inputting area, which makes it possible to establish the address to be ranked at a hierarchy level lower than that of the address established by the manager, is also displayed, so that the user can establish an arbitral address under such the limitation that the user succeeds the addresses established by the manager. Accordingly, it becomes possible to improve the user's convenience, while maintaining a security aspect of the data concerned. Further, since the address established by the user is registered so that the various kinds of screens reflected by the registered address will be displayed in the next time, it becomes possible to further improve the user's convenience. Still further, when the manager establishes the absence of the manager's limitation from the manager's limitation change screen, it becomes possible for the user to freely establish the address without succeeding the manager's setting address. Accordingly, it becomes possible to heighten the general versatility of the method embodied in the present invention.

In this connection, in the foregoing, the system including an image forming apparatus has been described as an embodiment of the present invention. The scope of the present invention is not limited to the aforementioned embodiment. The present invention is also applicable for an arbitral system in which an address for indicating a data storing/referring destination is settable, as well.

The present invention is available for a system in which an address for indicating a data storing/referring destination is settable, and specifically available for a system including an image forming apparatus.

According to a method for limiting an address setting operation and a program for limiting an address setting operation, embodied in the present invention, the following effects can be achieved.

According to the first effect of the present invention, it becomes possible to maintain security aspects of the system in which an address for indicating a data storing/referring destination is settable.

This is because, the addresses established in advance by the manager are displayed on the screen for setting an address, in such a manner that the user is only possible for setting an address to be ranked at a hierarchy level lower than that of each of the addresses established in advance by the manager.

According to the second effect of the present invention, it becomes possible to improve the usability and convenience of the user in the abovementioned system.

This is because, the user can freely establish an address, as far as the established address is to be ranked at a hierarchy level lower than that of a concerned one of the addresses, established in advance by the manager. Further, even when the manager changes the host name, etc., it is unnecessary for each of the users to change the address to be established by the user concerned. Still further, the address established by each of the users is stored, so as to display the user-established address at the next time.

According to the third effect of the present invention, it becomes possible to heighten the versatility of the address setting limitation method, so as to make it applicable for various kinds of systems.

This is because, since the presence or absence of the manager's limitation is changeable, it becomes possible for the manager to apply an appropriate limitation to the address setting operation in accordance with the utility mode of the system concerned.

While the preferred embodiments of the present invention have been described using specific term, such description is for illustrative purpose only, and it is to be understood that changes and variations may be made without departing from the spirit and scope of the appended claims.

What is claimed is:

1. An address setting limitation method to be employed in a system in which an address for indicating a storing/referring destination of a data is settable, comprising:
displaying a first screen on which a first address established in advance by a manager is displayed; and
displaying a second screen from which a user establishes a second address;
wherein both the first address and an inputting area, from which the second address to be ranked at a hierarchy level lower than that of the first address is settable, are displayed on the second screen.

2. The address setting limitation method of claim 1,
wherein a plurality of first addresses established in advance by the manager are displayed on the first screen in a selectable manner; and
wherein selected first addresses, defined as at least a part of the plurality of first addresses selected from the first screen, and the inputting area from which, with respect to each of the selected first addresses, the second address to be ranked at a hierarchy level lower than that of said each of the selected first address is settable, are displayed on the second screen.

3. The address setting limitation method of claim 1, further comprising:
connecting the second address inputted from the inputting area with the first address in such a manner that the second address is positioned at the hierarchy level lower than that of the first address, when an address registering operation is instructed from the second screen, so as to create a third address in which the first address and the second address are combined with each other; and
registering the third address as an address inherent to the user.

4. The address setting limitation method of claim 1, further comprising:
displaying a third screen for setting a presence or absence of a manager's limitation;
wherein, when the absence of the manager's limitation is established from the third screen, the first address established by the manager is not displayed on the second screen, but the second address inputted from the inputting area is registered as an address inherent to the user.

5. The address setting limitation method of claim 1,
wherein the data is a print data based on which an image forming apparatus performs an printing operation, or a scan data which is acquired by the image forming apparatus.

6. A computer readable storage medium storing a computer executable program to be employed in a system in which an address for indicating a storing/referring destination of a data is settable, the program being executable by a computer to cause the computer to perform a process comprising:
displaying a first screen on which a first address established in advance by a manager is displayed on a displaying section; and
displaying a second screen from which a user establishes a second address on the displaying section;
wherein both the first address and an inputting area, from which the second address to be ranked at a hierarchy level lower than that of the first address is settable, are displayed on the second screen.

7. The computer readable storage medium of claim 6,
wherein a plurality of first addresses established in advance by the manager are displayed on the first screen in a selectable manner; and
wherein selected first addresses, defined as at least a part of the plurality of first addresses selected from the first screen, and the inputting area from which, with respect to each of the selected first addresses, the second address to be ranked at a hierarchy level lower than that of said each of the selected first address is settable, are displayed on the second screen.

8. The computer readable storage medium of claim 6,
wherein the process further comprises:
connecting the second address inputted from the inputting area with the first address in such a manner that the second address is positioned at the hierarchy level lower than that of the first address, when an address list screen of the user is made to be displayed on the displaying section, so as to create a third address in which the first address and the second address are combined with each other; and
displaying the third address.

9. The computer readable storage medium of claim 6,
wherein the process further comprises:
displaying a third screen for setting a presence or absence of a manager's limitation; and
wherein, when the absence of the manager's limitation is established from the third screen, the first address established by the manager is not displayed on the second screen, but the second address inputted from the inputting area is displayed, when the address list screen of the user is made to be displayed on the displaying section.

10. The computer readable storage medium of claim 6,
wherein the data is a print data based on which an image forming apparatus performs an printing operation, or a scan data which is acquired by the image forming apparatus.
